(19) United States
(12) Patent Application Publication
(10) Pub. No.: US 2006/0026428 A1
(43) Pub. Date: Feb. 2, 2006

(54) Key synchronization in an image cryptographic systems

(75) Inventors: Geert Jan Schrijen, Eindhoven (NL); Pim Theo Tuyls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,238

(22) PCT Filed: Oct. 31, 2003
(86) PCT No.: PCT/IB03/04874

§ 371 Date: May 24, 2005

(30) Foreign Application Priority Data
Nov. 29, 2002 (EP) 02079994.6

(51) Int. Cl. H04L 9/00

(52) U.S. Cl. 713/171

(57) ABSTRACT

A system for visual cryptography comprises a server (1) for encrypting a series of images using a set of keys, a terminal (2) for displaying the encrypted images, a transmission medium (4) for transmitting the encrypting images from the server to the terminal (2), and a decryption device (3) for decrypting the encrypted image displayed on the terminal. Subsequent images are encrypted using different keys chosen from the set of keys. These encrypted images and a feedback mechanism are provided to test whether the server and the terminal utilize the same keys at a particular instant. Preferably at least two encrypted images are provided simultaneously as parts of a larger image, thus allowing a user of the decryption device to indicate which key decrypts the image correctly.

The present invention relates to key synchronization in cryptographic systems. More in particular, the present invention relates to a method of and a system for synchronizing a first key set in an encryption device and a second key set in a decryption device, the encryption device being capable of encrypting images and the decryption device being capable of decrypting images.

It is well known to use key sets in cryptographic systems, subsequent messages being encrypted using different keys of the key set. The use of different keys for different messages makes it much harder for an eavesdropper to decrypt any of the messages. In addition, knowledge of a single key will only allow a single message to be decrypted.

It is, of course, necessary to synchronize the key sets, that is, to ensure that both the encryption device and the decryption device use the same key of the key set to encrypt or decrypt the same message. If this synchronization is lost, it will not be possible to decrypt the messages correctly.

It is further known to encrypt an image in order to prevent the image being recognized or to prevent its contents being read by unauthorized persons. One technique of encrypting an image is disclosed in, for example, European Patent Application EP 0 260 815. This technique, also known as visual cryptography, employs two patterns or “shares”, each of which cannot be recognized individually, which are overlaid to produce a recognizable image. To this end, the original image is transformed into two randomized image patterns, neither of which contains any perceptible image information. One of these patterns is printed on a transparency to act as a key. When such patterns are overlaid, the patterns are combined and thus “decrypted” in the eye of the viewer.

Rather than working with transparencies which are cumbersome when larger amounts of individually encrypted images are to be viewed, it has been proposed to use a decrypting (decryption) device. Two types of image decrypting devices can be distinguished: transparent and non-transparent devices.

Transparent decrypting devices essentially mimic the transparent sheets used in the Prior Art and display one pattern (“share”) of the encrypted image. As the decrypting device is at least partially transparent, the other pattern of the image can be seen through the device and the two image patterns are combined in the eye of the viewer as before. The advantage of using a transparent device instead of a transparent sheet is that the device is capable of displaying a plurality of image parts rather than a single image part. Thus subsequent images can use different keys. Transparent decrypting devices advantageously use LCD (Liquid Crystal Display) screens, two such screens being overlaid to “decrypt” the encrypted image so as to reconstruct the original image. A suitable example of a transparent device in which LCD screens are employed is described in European Patent Application 02075527.8 [PHNL020121]. In the device of said European Patent Application, use is made of the polarization rotating effect of liquid crystal cells in a liquid crystal display. This allows a very convenient encrypting and decrypting of black-and-white images. European Patent Application 02078660.4 [PHNL020804] describes a transparent decrypting device which also allows color images to be decrypted.

Non-transparent decrypting devices are capable of sensing the encrypted image, performing a decryption and displaying the decrypted image. The decryption is carried out in the device itself and the display shows the complete, decrypted image, while the encrypted image is masked by the device. An example of such a decrypting device is described in European Patent Application 02079579.5 [PHNL021058]. The decrypting device may use a key to decrypt the images.

An image decrypting device will generally require at least one key to decrypt an image. However, to decrypt multiple images in a cryptographically secure manner it is necessary to employ a key set of which different keys are used to decrypt subsequent images. The use of a key set does, however, introduce the problem of key set synchronization. Even when a certain key sequence is predetermined, the encryption device and the decryption device may accidentally change keys at different moments, or not change keys at all, resulting in a loss of key synchronization. This, in turn, will result in the decryption device not being capable of decrypting the encrypted images.

It is therefore an object of the present invention to provide a method and system for establishing the synchronization of an encryption device and a decryption device in a simple yet effective manner.

It is another object of the present invention to provide a method and system for establishing the synchronization of an image encryption device and an image decryption device.

Accordingly, the present invention provides a method of synchronizing a first key set in an encryption device and a second key set in a decryption device, the method comprising the steps of:
the encryption device producing a series of encrypted images using respective keys of the first key set,
the encryption device transmitting the series of encrypted images to a display device,
the display device displaying the encrypted images,
the decryption device decrypting the encrypted images using a key of a second key set and displaying the decrypted images,
the display device receiving from a user an indication as to which decrypted image was correctly displayed, and
the display device passing said indication to the encryption device.

In accordance with the present invention, therefore, the display device displays several encrypted images which have been encrypted using several different keys. The decryption device decrypts (or, strictly speaking, attempts to decrypt) these encrypted images using a single key of the second key set. As several images encrypted using distinct keys are decrypted using a single key, at most one image is correctly decrypted and will be displayed in a recognizable form. All other images will be decrypted incorrectly (that is, using the incorrect key) and will not be recognizable. By receiving a user indication which image is recognizable and is therefore correctly decrypted, the image is identified which was encrypted using a key corresponding with the present key of the decryption device. By passing this indication to the encryption device, the particular key corresponding with the present key of the decryption device is identified and synchronization of the devices is accomplished.

It is noted that instead of the encryption device using several keys to encrypt images and the decryption device using a single key to decrypt these images, it can be envisaged that the encryption device encrypts a single image and that the decryption device uses multiple keys to decrypt the single image. However, the use of a single key for synchronization purposes in the decryption device is preferred.

It is possible for the decryption device to display the decrypted images individually, that is, one at a time. It is preferred, however, that the decryption device displays at least two decrypted images simultaneously. By displaying several (for example four or six) decrypted images at the same time, the synchronization process is accelerated and is less burdensome for the user. A further acceleration of the synchronization process is achieved when the display device displays at least two encrypted images simultaneously. This allows a suitably arranged decryption device to decrypt at least two encrypted images substantially simultaneously.

In a particularly advantageous embodiment, the encryption device produces an additional series of encrypted images using respective keys of a third key set, and the decryption device decrypts the additional series of encrypted images using a fourth key set, said additional series not being used for synchronizing, the third key set being linked to the first key set. That is, the images and associated key sets used for synchronization are distinct from the images and associated key sets used for other purposes. This provides a higher level of security as any knowledge an attacker may obtain of the keys used for synchronization will not allow him to decrypt any other images.

Although the images used for synchronization may be distinct images having no particular mutual relationship, it is preferred that the series of encrypted images is produced by encrypting parts of a larger image. That is, an image is divided into at least two but preferably four, six, eight or possibly twelve parts, and each part is encrypted using a different key. As a result, at most one part of the image will be correctly displayed by the decryption device. In this way, a quicker synchronization is achieved.

The first and the third key sets may be linked by sequence numbers, memory vectors or other suitable means. The second and the fourth key sets may be linked in the same manner. The first and the second key sets may be identical but this is not necessary, the key of the second key set should enable the decryption device to decrypt an image encrypted by the encryption device using the corresponding key of the first key set. Similarly, the third and the fourth key sets may be identical but are not necessarily identical. As will be clear from the above, the first and third key sets may be identical.

The images used for synchronization purposes may show an identification token, such as a number, letter or name, to allow an easy recognition of the correctly decrypted image. This token could identify a key on the display device which could be pressed to identify the correctly decrypted image.

Although various ways of receiving user input can be envisaged, it is preferred that the display device receives the user indication via a pointing device and/or a keyboard. A suitable pointing device is a so-called mouse, although other pointing devices, such as a “track ball” or a “touch-pad mouse” can also be used. The term “keyboard” as used here is meant to include other key arrangements, such as key pads. Alternatively, the use of touch-screen technology may be advantageous.

The images used for synchronization according to the present invention may be monochrome images or color images. Although various techniques may be used for rendering color images in visual cryptography and similar applications, the liquid crystal display techniques described in European Patent Application 02078660.4 [PHNL020804EPP] are particularly suitable.

The present invention further provides a system for synchronizing a first key set in an encryption device and a second key set in a decryption device, the system comprising:
an encryption device for producing a series of encrypted images using respective keys of the first key set and transmitting the series of encrypted images to a display device,
a display device for displaying the encrypted images,
a decryption device for decrypting the encrypted images using a key of the second key set and displaying the decrypted images,
   wherein the display device is provided with:
input means for receiving from a user an indication as to which decrypted image was correctly displayed, and
transmission means for transmitting said indication to the encryption device.
   A system of this kind allows a quick and convenient synchronization.

The present invention will further be explained below with reference to exemplary embodiments illustrated in the accompanying drawings, in which:

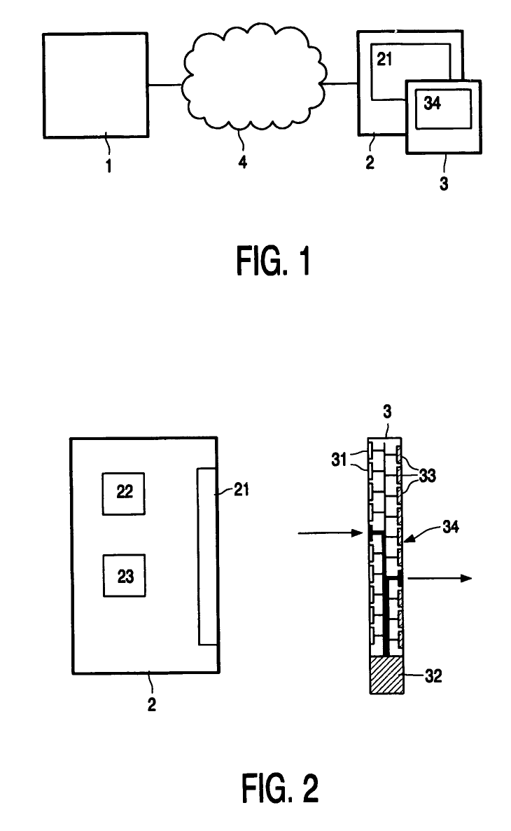

FIG. 1 schematically shows a cryptographic system according to the present invention.

FIG. 2 schematically shows, in cross-section, a decryptor for use in the system of FIG. 1.

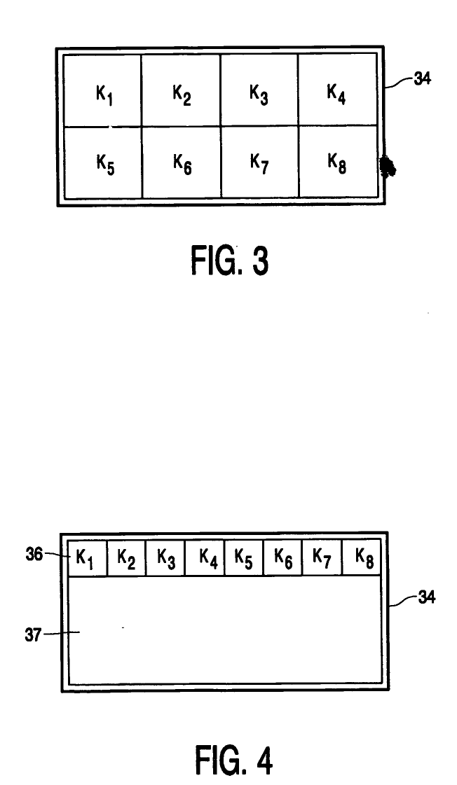

FIG. 3 schematically shows a first embodiment of a decryptor screen in accordance with the present invention.

FIG. 4 schematically shows a second embodiment of a decryptor screen according to the present invention.

The system shown merely by way of non-limiting example in FIG. 1 comprises a server 1, a terminal 2, a decryptor 3 and a communication network 4. The server 1 produces and encrypts images which are transmitted via the communication network 4 to the terminal 2. The communication network 4 may be constituted by a dedicated network such as a LAN, a telephone network (POTS), the Internet, or a simple cable or wire. Both the server 1 and the terminal 2 may be dedicated devices or may be constituted by general purpose computers with, at least in the case of terminal 2, a display screen 21. The decryptor 3 is a cryptographic device which will be discussed in more detail below. The server 1 and the decryptor 3 are both provided with at least one key set consisting of a plurality of cryptographic keys. These keys are used in a suitable cryptographic process, such as DES. The particular cryptographic process used is not essential.

In a first embodiment (not shown), the decryptor 3 is a decryption device of the transparent type which includes a display screen for displaying an image pattern or “share”. This image pattern acts as a key to decrypt (at least part of) an encrypted image shown on the display device 2. The display of the decryptor is transparent so as to allow the viewer to see both the image pattern displayed by the decryptor and the image pattern displayed on the screen 21 of the display device 2. An example of such a decryptor is described in European Patent Application 02075527.8 [PHNL020121] mentioned above. It is noted that the image patterns or “shares” mentioned here are distinct from the sub-images which will later be discussed with reference to FIGS. 3 and 4.

In a second embodiment, as shown in FIG. 2, the decryptor 3 is a decryption device of the non-transparent type which includes sensors 31 for sensing a displayed image, a processor 32 with an associated memory for performing cryptographic operations on the sensed image, and display elements 33 forming a display screen (34 in FIG. 1) for displaying the decrypted image. Electrical conductors or optical fibers 34 connect the sensors 31, the processor 32 and the display elements 33. A set of cryptographic keys is stored in the processor memory. The decryptor 3 therefore is capable of sensing an encrypted image, decrypting the image, and displaying the resulting decrypted image. While the terminal 2 is a non-trusted device, the decryptor 3 is a trusted device which is preferably carried by its user and stored in a safe place when not in use. In this way the keys stored in the decryptor are not compromised.

The synchronization of key sets in the system of FIG. 1 is accomplished as follows. The server (encryption device) 1 produces a series of images and encrypts these images using different keys of its key set. These images may be regular images or specific test images. The encrypted images are transmitted to the terminal (display device) 2 which displays the images. As the terminal 2 is not in possession of the keys, it is not able to decrypt the encrypted images. The displayed encrypted images (image patterns) contain no perceptible information and may have the appearance of random images (“snow”). The user positions her decryptor (3 in FIG. 2) such that the decryptor covers the displayed images. Using a key of its key set, the decryptor then either produces a suitable key image pattern (transparent embodiment) or senses and decrypts the images and displays the resulting decrypted images.

The key sets of the server and the decryptor are effectively identical, that is, each key of the server key set, when used in the server encryption process, produces an image which can be decrypted using an associated key in the decryptor 1 set, when used in the decryptor decryption process. In most embodiments the server key set and the decryptor key set will be identical, but this is not necessarily the case. Both key sets can be stored in the respective devices but are preferably generated from an initial value (“seed”) using a pseudo-random generator which is well known in the art.

The test images are, as explained above, produced using distinct keys but are decrypted using a single key. As a result, at most one image will be decrypted correctly, all other images will still be unrecognizable after “decryption”. The correctly decrypted image has therefore been encrypted using the key of the server key set associated with the decryption key. The present invention provides for a feedback mechanism for feeding back this information to the server. To this end, the user inputs a user indication, in the case of a transparent decryptor for example by pointing at the correctly decrypted image using a input device (schematically indicated 22 in FIG. 2). Such an input device may be a pointing device such as a mouse, a track ball, or a similar device. Instead of a pointing device, a keyboard or keypad could be used to input the user indication. Alternatively, a touch screen may be used in the case of a transparent decryptor. Irrespective of the type of decryptor, the correctly decrypted image may identify a key on a keyboard of the terminal, thus providing the user indication.

The terminal 2 then transmits the user indication back to the server 1, for example via the network 4 which may be coupled to the terminal 2 through a transmission device (schematically indicated 23 ir. FIG. 2), such as a modem. The server 1, upon receipt of the user indication, is able to select the key which corresponds with the key used by the decryptor 3. In this way, the key sets of the server and the decryptor are synchronized. Assuming that the server selects a different key for every image it encrypts, it selects the next key of a predetermined sequence when the next image is to be transmitted. This next image may be a regular image, as opposed to the test images used for synchrorization. Alternatively, the test images are no different from regular images.

After inputting the user indication into the terminal, the user may also input a user indication into the decryptor to allow the decryptor to select the next key of a predetermined sequence for decrypting the next image.

The images used for synchronization may be used in various ways. In a first embodiment, the images are decrypted and displayed sequentially. In a second embodiment, at least some of the images are displayed simultaneously, resulting in a much quicker synchronization. In this embodiment, at least some images are sub-images which are part of a larger image. This is schematically represented in FIG. 3 where the encrypted images (image patterns) are identified by their respective keys K₁-K₈. It will be understood that the actual keys will not be displayed, only images encrypted using these keys. It will further be understood that the number of images is not limited to eight and that two, three, four or twenty test images may be displayed simultaneously. These images together form an image which is displayed on the display 34 of the decryptor (3 in FIG. 2). The actual decryption process of the simultaneously displayed test images need not be simultaneous.

In a preferred embodiment the (total) image shown on the display of the decryptor (3 in FIG. 2) has at least two sections, as schematically shown in FIG. 4. A first section 36 serves to display test images, that is, images used for synchronization purposes. A second section 37 serves to display regular images, that is, images not used for synchronization purposes. This arrangement provides the possibility of an immediate re-synchronization when key synchronization is lost: if the regular image in the second section 37 is unrecognizable (that is, is decrypted using the incorrect key), one of the test images shown in the first section 36 may still be recognizable and be indicative of the correct key. In a further preferred embodiment, the sections 36 and 37 have different associated key sets. That is, the key set used for synchronization purposes is linked, but not identical, to the key set used for decrypting regular images. This arrangement provides an additional level of security as knowledge of the test key set does not allow regular images to be decrypted. The test and regular key sets may be linked using key numbers, memory vectors or other mechanisms.

The present invention can also be used with Prior Art transparencies instead of the decryption devices described above. In that case, the “decryption device” is constituted by a transparency, each transparency representing a key of the (second) key set.

The present invention is based upon the insight that a visual inspection by a user can quickly determine whether a correct key has been used for the decryption of an image, and the further insight that user feedback pertaining to multiple images provides a convenient and efficient mechanism for the selection of the correct key. Another useful insight employed in this invention is that an untrusted device (i.e. the display device) can be used to provide information pertaining to keys, as the untrusted device has no knowledge of the keys themselves.

Although the present invention is in particular applicable in systems for cryptographically transferring images, such as “visual cryptography”, it can also be applied in other cryptographic systems where other data items than images are cryptographically protected. It can be envisaged, for instance, that the present invention be applied in computer systems where encrypted data (files) are transferred between computers, the computer screens being used for key synchronization.

It is noted that any terms used in this documents should not be construed so as limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A method of synchronizing a first key set in an encryption device and a second key set in a decryption device, the method comprising the steps of:
the encryption device producing a series of encrypted images using respective keys of the first key set, the encryption device transmitting the series of encrypted images to a display device,
the display device displaying the encrypted images,
the decryption device decrypting the encrypted images using a key of the second key set and displaying the decrypted images,
the display device receiving from a user an indication as to which decrypted image was correctly displayed, and
the display device transmitting said indication to the encryption device.

2. The method according to claim 1, wherein the decryption device displays at least two decrypted images simultaneously.

3. The method according to claim 2, wherein the display device displays at least two encrypted images simultaneously.

4. The method according to claim 1, wherein the series of encrypted images is produced by encrypting parts of a larger image.

5. The method according to claim 1, wherein the encryption device produces an additional series of encrypted images using respective keys of a third key set, wherein the decryption device decrypts the additional series of encrypted images using a fourth key set, said additional series not being used for synchronizing, and wherein the third key set is linked to the first key set.

6. The method according to claim 1, wherein the display device receives the indication via a pointing device and/or a keyboard.

7. A system for synchronizing a first key set in an encryption device and a second key set in a decryption device, the system comprising:
an encryption device for producing a series of encrypted images using respective keys of the first key set and transmitting the series of encrypted images to a display device,
a display device for displaying the encrypted images,
a decryption device for decrypting the encrypted images using a key of the second key set and displaying the decrypted images, wherein the display device is provided with:
input means for receiving from a user an indication as to which decrypted image was correctly displayed, and
transmission means for transmitting said indication to the encryption device.

8. The system according to claim 7, wherein the decryption device is capable of displaying at least two decrypted images simultaneously.

9. The system according to claim 8, wherein the display device is capable of displaying at least two encrypted images simultaneously.

10. The system according to claim 7, wherein the series of encrypted images is produced by encrypting parts of a larger image.

11. The system according to claim 7, wherein the encryption device is capable of producing an additional series of encrypted images using respective keys of a third key set, wherein the decryption device is capable of decrypting the additional series of encrypted images using a fourth key set, said additional series not being used for synchronizing, and wherein the third key set is linked to the first key set.

12. The system according to claim 7, wherein the display device is capable of receiving the indication via a pointing device and/or a keyboard.
